(19) United States
(12) Patent Application Publication
(10) Pub. No.: US 2026/0339161 A1
(43) Pub. Date: Oct. 29, 2026

(54) WIDE-ANGLE BEAM STEERING WITH REDUCED CONTROL COMPLEXITY

(71) Applicant: GlobalFoundries Singapore Pte. Ltd., Singapore (SG)

(72) Inventors: You Sian James TAN, Singapore (SG); Xianshu LUO, Singapore (SG)

(21) Appl. No.: 19/123,329

(22) PCT Filed: Nov. 29, 2022
(86) PCT No.: PCT/SG2022/050868

§ 371 Date: Apr. 22, 2025

(51) Int. Cl. G02F 1/295

(52) U.S. Cl. CPC G02F 1/2955

(57) ABSTRACT

An optical phased array which comprises photonic components for on-chip beam forming and steering, and is adapted to use at least one optical phase shift control element which is configured to be electrically modulated to steer the direction of an output optical field of an emitted beam having a wavelength which ranges from visible light to a short-wavelength infrared region. The photonic components comprise simultaneously-modulated optical phase shifters of monotonically varying dimensions independently positioned on, below, or otherwise integrated to each optical waveguide connected to the beam emitters. Such an optical phased array is useful in LiDAR systems, and transceivers.

### FIELD

This invention relates to beam steering of optical beam, e.g., light, and more particularly to an optical phased array for steering an optical beam using a control system with significantly reduced complexity.

### BACKGROUND

Non-guided signal transmission—i.e., signal propagation that is not physically guided within a solid medium—is complementary to signal transmission via bounded media especially in cases when setting up physical channels for guided signal transmission would incur extortionately high cost (e.g., in areas where they are not already built out), and when signal access or mobility to the region to be reached is not otherwise convenient or possible. Such unbounded transmission can generally be divided into mechanical waves (e.g., acoustic/sound waves) and non-mechanical waves (i.e., electromagnetic waves). The choice of transmission signal type largely depends on the environmental conditions and applications. For example, in the ocean with large bodies of ionised water, sound waves (and not radio waves) are used due to their high volumetric mass density (thus allowing relatively efficient transmission) and to the fact that they are not considerably impeded by the presence of ionized charges in the medium.

Signal transmission in air—with substantially lower volumetric mass density, however—requires signals that do not easily fade out at a defined propagation distance in the medium, such as electromagnetic waves. While both radio and optical waves are both electromagnetic waves respectively at ~meter (m) and ~ micrometer (μm) wavelength range, optical waves in the infrared (~1.55 μm) wavelengths are preferred when high data transmission rates (e.g., ~gigabytes per second (Gbps) in LiFi systems) or detailed map of immediate surroundings (e.g., of ~millimeter (mm) resolution at ~m distance in LIDAR systems) are required.

In applications involving non-guided optical signal transmission, it can be important to not only be able to specifically direct an optical beam to an intended location, but to also be able to actively steer the beam at varying directions. For example, a LiDAR system used to determine the ranges of a structural region has to be able to actively steer a beam to different points in the region to be mapped. Approaches to steering an optical beam include mechanically altering structures of a certain optical properties (e.g., in optical microelectromechanical (MEMS) systems), changing the material structural properties (e.g, in liquid crystals), and modulating the optical properties of a material (e.g., using vertical-cavity surface-emitting laser). One of the more common approach to on-chip beam steering via modulation of optical property is to control the optical amplitude and/or optical phase of optical waves from an array of beam scatterers. Beam steering in such ‘optical phased array’ (OPA) is typically enabled by inducing refractive index shift to the optical waveguides leading to, and/or in vicinity to the beam scatterers.

Conventionally, OPAs require complicated control system—each emitter (in the form of scatterers) independently require one control element. Given that the extent of beam directionality (i.e., field of view or angular reach) is directly governed by the number of emitters in the OPA, the number of control elements for a working OPA can be unfavourably large. There have been attempts to mitigate the unwieldy reliance on large number of control elements in the OPA for beam steering. Example of this attempt includes simultaneously heating, via a single voltage supply, the optical waveguides leading to the beam emitters. For instance, Acoleyan K. V. et al. in the academic journal publication Opt. Lett. 34 9, pp. 1477-1479 (2009) reports beam steering controlled using a single voltage supply by simultaneously heating an array of optical waveguides using heating element in the form of indium tin oxide/AlGaAs Schottky junctions patterned across the optical waveguides with linearly increasing length in a serpentine shape. However, heating across the optical waveguides introduces unwanted steering performance (e.g., field of view) degradation due to thermal crosstalk i.e., temperature gradient experienced by a waveguide due to the influx of heat from a nearby heat source such as that above an adjacent waveguide. Moreover, as electrical resistance—which results in the generation of heat-increases with bends, the higher heat generation efficiency at the waveguide array edges (where the bends are mainly concentrated) comes at the expense of less uniform (which causes less predictable) heat distribution along each waveguide and therefore reduced precision to heat control. Given that OPA relies mainly on regular optical phase shift difference, it is sensitive to optical phase shift difference mismatch. As such, the lack of precise heat control using the heating system is likely the cause of low (less than) ~10° angular steering angle, e.g., 2.3° in Acoleyan K. V. et al.

It would be desirable to provide an improved photonic component of elegant design, with both a reduced optical phase shift control complexity and enhanced field of view.

### SUMMARY

In accordance with a first aspect, there is provided an optical phased array which comprises photonic components for on-chip beam forming and steering, and is adapted to use at least one phase shift control element which is configured to be electrically modulated to steer the direction of an output optical field of an emitted beam having a wavelength which ranges from visible light to a short-wavelength infrared region. The photonic components comprise simultaneously-modulated optical phase shifters of monotonically varying dimensions independently positioned on, below, or otherwise integrated to each optical waveguide connected to the beam emitters. Such an optical phased array is useful in LiDAR systems, and transceivers.

Accordingly, an optical phased array (OPA) comprises:
photonic components for on-chip beam forming and steering, the photonic components comprising:
optical phase shifters having monotonically varying dimensions across rows thereof and operably configured to simultaneously modulate optical phases of optical fields in optical waveguides which are operably coupled to optical beam emitters, wherein each optical phase shifter traverses at most one of the optical waveguides.

In some embodiments of the first aspect, the optical phased array further comprises: at least one electrical control element operably configured to control at least some of the rows of the optical phase shifters, wherein a count of the at least one electrical control element is less than a count of the rows of the optical phase shifters.

In some embodiments of the first aspect, the optical phased array further comprises: optical splitters having optical splitter outputs operably coupled to the rows of the optical phase shifters, the optical splitters being operably configured to produce the optical splitter outputs having no or negligible optical amplitude difference and no or negligible optical phase difference across the rows.

In accordance with a second aspect, a method is provided for operating an optical phased array which comprises photonic components for on-chip beam forming and steering, the method comprising:
controlling optical beams in a steering direction which is azimuth to a propagation direction of optical fields in optical waveguides by:
   simultaneously modulating, by optical phase shifters, optical phases of the optical fields in the optical waveguides which are operably coupled to optical beam emitters producing the optical beams, wherein the optical phase shifters having monotonically varying dimensions across rows thereof, and wherein each optical phase shifter traverses at most one of the optical waveguides.

In some embodiments of the second aspect, the step of simultaneously modulating, by the optical phase shifters, the optical phases of the optical field in the optical waveguides is by: controlling, by at least one electrical control element, at least some of the rows of the optical phase shifters, wherein a count of the at least one electrical control element is less than a count of the rows of the optical beam emitters.

In some embodiments of the second aspect, the method further comprises: producing, by optical splitters operably coupled to the rows of the optical phase shifters, optical splitter outputs having no or negligible optical amplitude difference and no or negligible optical phase difference across the rows.

From the foregoing disclosure and following more detailed description of various embodiments it will be apparent to those skilled in the art that the present invention provides a significant advance in the technology of OPAs. Particularly significant in this regard is the potential the invention affords for providing a wide field of view (large angular steering angle) controlled using simultaneously-modulated optical phase shifters. Additional features and advantages of various embodiments will be better understood in view of the detailed description provided below.

### BRIEF DESCRIPTION OF THE DRAWINGS

FIG. 1 shows a schematic diagram illustrating the use of optical phase shifters to steer an optical beam by simultaneously modulating the optical phases of the optical field in the waveguides along the rows of the OPA using ≤M electrical control elements connected to the phase shifters in accordance with certain embodiments disclosed herein, where M is the total number of OPA rows.

FIG. 2 shows a schematic diagram illustrating the use of optical phase shifters to modulate the optical phases of the optical field in the waveguides along the rows of the OPA in accordance with certain embodiments disclosed herein.

FIG. 3 shows a schematic diagram illustrating the use of optical phase shifters to modulate the optical phases of the optical field in the waveguides along the rows of the OPA to define optical phase difference(s) Δφₘ relative to the adjacent waveguides in accordance with certain embodiments disclosed herein, at a last column.

FIG. 4 shows a schematic diagram illustrating the use of optical phase shifters to modulate the optical phases of the optical field φₘₙ scattered out-of-plane by beam emitters positioned after column n of the optical phase shifters, which in turn modulates the directionality of the emitted optical beam θ_{y} in the y-axis, in accordance with certain embodiments disclosed herein.

FIG. 5 shows a schematic diagram illustrating the use of one column of optical phase shifters to steer an optical beam by simultaneously modulating the optical phases of the optical field in the waveguides along the rows of the OPA using one set of electrical control elements connected to the phase shifters in an example of the model in FIG. 1, in accordance with an embodiment disclosed herein.

FIG. 6 is a table showing a partial isometric schematic view of optical splitters (MMI optical splitter, and Y-splitter in the two examples of the model of FIG. 6), in accordance with several embodiments disclosed herein.

FIG. 7 is a table showing a partial isometric schematic view of optical phase shifters (metal thermo-optic phase shifters, highly-doped semiconductor thermo-optic phase shifter, and doped semiconductor plasma dispersion effect-based phase shifter) in the four examples of the model of FIG. 7), in accordance with several embodiments disclosed herein.

FIG. 8 shows an example experimental measurement plot of a phase shift Δφ with respect to length of modulation element (metal heater) of a metal thermo-optic phase shifter, according to one embodiment of metal thermo-optic phase shifter disclosed herein.

FIG. 9 shows an example numerical simulation plot of a phase shift Δφ with respect to length of modulation element (doped region) of a pn-doped optical phase shifter, in accordance with an embodiment disclosed herein.

FIG. 10 is a table showing schematic diagrams that illustrate the optical phase shifters (thermo-optic and pn-doped) of monotonically-varying length that enables simultaneous modulation of optical phases of the optical field in the waveguides along the rows of the OPA using one set of electrical control elements connected to the phase shifters, in accordance with certain embodiments disclosed herein.

FIG. 11 is an experimental characterisation plot of resulting thermal crosstalk of optical phase shifters in accordance with several embodiments of the thermo-optic phase shifters disclosed herein at different physical distance of a thermo-optic heater from adjacent waveguide.

FIG. 12 is a table comparing polar plots of resulting far field intensities with respect to an azimuth and a zenith viewing angle at different optical phase differences of the input optical field sent to the waveguides Δφ_{y} (that is, optical phase Δφ in the y-direction) which may be modulated using phase shifters positioned on or otherwise integrated to the waveguides to the OPA beam emitters.

FIG. 13 is a table showing a schematic of different examples of optical phase compensating element 190, in accordance with several embodiments of optical phase compensating elements.

FIG. 14 shows a flowchart 1400 describing a method for operating an OPA which comprises photonic components for on-chip beam forming and steering.

It should be understood that the appended drawings are not necessarily to scale, presenting a somewhat simplified representation of various features illustrative of the basic principles of the invention. The specific design features of the OPA as disclosed here, including, for example, the specific dimensions of the optical phase shifters, will be determined in part by the particular intended application and use environment. Certain features of the illustrated embodiments have been enlarged or distorted relative to others to help provide clear understanding. In particular, thin features may be thickened, for example, for clarity of illustration. All references to dimension, direction and position, unless otherwise indicated, refer to the orientation illustrated in the drawings.

### DETAILED DESCRIPTION OF CERTAIN EMBODIMENTS

It should be understood that the articles “a”, “an” and “the” as used with regard to a feature or element include a reference to one or more of the features or elements. The term “and/or” includes any and all combinations of one or more of the associated feature or element. The terms “comprising”, “including”, “having”, and any of their related terms, as used in description and claims, are intended to be open-ended and mean that there may be additional features or elements other than the listed ones. Identifiers such as “first”, “second”, “third”, and so on, are used merely as labels, and are not intended to impose numerical requirements on their objects, nor construed in a manner imposing any relative position or time sequence between limitations. The term “to” may include a reference to “configured to”, “adapted to”, and “constructed and arranged to” which may be used interchangeably.

The term “coupled” and the phrase “operably coupled” may be used to include a reference to operational sense and may also include, but not necessarily limited to, a physical, optical, and/or electrical connection or coupling which may be direct or indirect. Thus, for example, two devices may be coupled or connected directly, or indirectly via one or more intermediary devices. Based on the present disclosure, a person of ordinary skill in the art will appreciate a variety of ways in which coupling exists in accordance with the aforementioned definition. The terms “coupled” and “connected” may be used interchangeably. The term “operably” includes a reference to the term “operatively”.

The terms “dimension”, “direction”, and “axis” may be used interchangeably.

It will be apparent to those skilled in the art, that is, to those who have knowledge or experience in this area of technology, that many uses and design variations are possible for the optical phased arrays (OPAs) disclosed here. The following detailed discussion of various alternate features and embodiments will illustrate the general principles of the invention with reference to an OPA using a control system with significantly reduced complexity to simultaneously modulate the beam steering angle while providing a wide field of view. This is in contrast to conventional OPAs using optical phase shifters that scale with the number of beam emitters, and OPAs using simultaneously controlled optical phase shifters with limited beam steering angle (less than 10°). The OPAs disclosed herein may be used as a beam steering system that may be part of LiDAR systems or free-space transceivers, for example; and may be used as both a transmitter and a receiver. Other embodiments suitable for other applications will be apparent to those skilled in the art given the benefit of this disclosure.

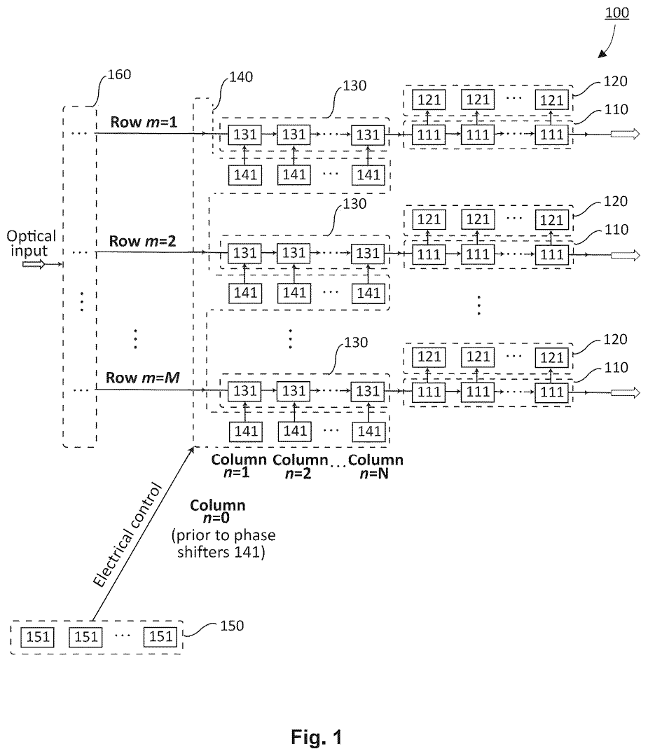

FIG. 1 shows a schematic diagram of an optical phased array (OPA) 100 illustrating the use of optical phase shifters to steer an optical beam by simultaneously modulating the optical phases of the optical field in the waveguides along the rows (M) of the OPA using ≤M electrical control elements connected to the phase shifters in accordance with certain embodiments disclosed herein. The OPA comprises an array of operably coupled photonic components formed in rows, having a plurality of rows (M≥1) of beam emitters 121 positioned generally adjacent to the side walls of, or embedded in a waveguide 110. The beam emitters 121 are operably coupled to at least one column (N≥1) of optical phase shifters 141 positioned generally adjacent to (below, above, to one side or the other of) or otherwise integrated to (or embedded in) waveguides 130, with the optical phase shifters 141 configured to be electrically modulated via ≤M electrical control elements 151. In other words, a count of electrical control elements is less than or equal to a count of rows of phase shifters 141. The electrical control element may be incorporated in the OPA or provided external of the OPA. The OPA enables steering optical beam in a different dimension than the x-dimension being along (azimuth to) the propagation direction of the optical field in the waveguides. The different dimension may be typically referred to as a y-dimension (i.e., at 90° azimuthally from the x-dimension). At least one optical phase shifter 141 (that forms the array 140) is positioned adjacent to or otherwise integrated to at least one waveguide 130 that is operably coupled to at least one waveguide 110, and a plurality of beam emitters (in the form of optical scatterers) 121 positioned along the waveguide 110 at the periodic points 111 of the waveguide 110. Each phase shifter 141 which forms part of the array 140 is configured to modulate the optical phases of the optical field in the optical waveguide 130. The OPA may be scaled up to have any number M of optical waveguides. Each m of the M optical waveguides 130 is configured to receive an optical field that propagates to m of the M optical waveguides 110. The subscripts m and n respectively denote the array row and column of optical phase shifters 141. In an embodiment, each column may comprise the same type of optical phase shifter. Optionally, each of the optical phase shifters may be formed as a different layer. Also, the optical phase shifters may comprise different materials.

Advantageously, such photonic components in the OPA may be implemented fully on-chip using standard fabrication techniques, such as lithography and deposition, and standard photonic materials including but are not limited to silicon (Si), silicon nitride (Si₃N₄), germanium (Ge), lithium niobate (Li₃NbO₃), barium titanite (BaTiO₃) and indium phosphide (InP), for example. Optionally, the wavelength of the input optical field may be in the short wavelength infrared region of the electromagnetic spectrum at 1.4 μm to 1.7 μm, for example. Visible wavelengths (0.38 μm to 0.75 μm), and near-infrared wavelengths (0.75 μm to 1.4 μm) may also be used, depending upon the application of the photonic component. One or more (≤M) electrical connections may be provided to the optical phase shifters. Further, in LiDAR systems, a controller may be adapted to work with the arrays 140 of optical phase shifters 141 positioned adjacent to or otherwise integrated to at least one waveguide 130 and receive an emitted optical field reflected from an object, and incorporate a processor to calculate the information about the surface characteristics of the object based on the reflected light received by the scatterers and the waveguide.

The waveguides (of and that are operably coupled to 110, 130, and optical splitter tree 160) may be circular or may be a rectangular (rib or ridge) waveguide having an elongate top surface and side walls extending from the top surface. A refractive index of the waveguide core may be larger than that of the surrounding waveguide cladding. The waveguide cladding may comprise undercladding and overcladding. The waveguide may comprise any of several different types of waveguides. For example, the waveguide may be a total internal reflection-based waveguide (which makes up the overwhelming majority of optical waveguides traditionally used in integrated photonics), a slot waveguide, or a surface plasmon polariton waveguide. Alternatively, an in-plane scattering waveguide may be used, such as waveguide formed from photonic crystals (which also use total internal reflection) and metamaterials. A composition of each of the plurality of waveguides may be, for example, at least one of the following: Si, SiO₂, BaTiO₃, Li₃NbO₃, InP, a III-V compound, a II-VI compound, and a polymer, for example. Each of the plurality of waveguides may be doped with a p-type or an n-type material. The waveguide may support any of the optical waveguide modes, for example, Transverse Electric mode and Transverse Magnetic mode. The scatterers/emitters 121 may be either Mie scatterers or Rayleigh scatterers. More particularly, Mie scattering refers primarily to scattering of optical field from scatterers whose diameter, width or diagonal is usually close to a wavelength of the incident optical field, whereas in Rayleigh scattering, the diameter, width or diagonal of the scatterers is at most one-tenth of the wavelength of the incident optical field. A composition of each of the plurality of scatterers may include, for example, at least one of the following: Si, SiO₂, BaTiO₃, Li₃NbO₃, InP, a III-V compound, a II-VI compound, and a polymer, for example. Each of the plurality of scatterers may be also doped with a positively-charged dopant (p-type material) or a negatively-charged dopant (n-type material). Types of positively-charged dopants comprise, for example, boron, gallium, and aluminium; while types of negatively-charged dopants comprise, for example, arsenic, phosphorus, and antimony. Each of the plurality of the scatterers may be embedded in the corresponding waveguide, and/or each of the plurality of scatterers may be in contact with a top wall or a side wall of the corresponding waveguide.

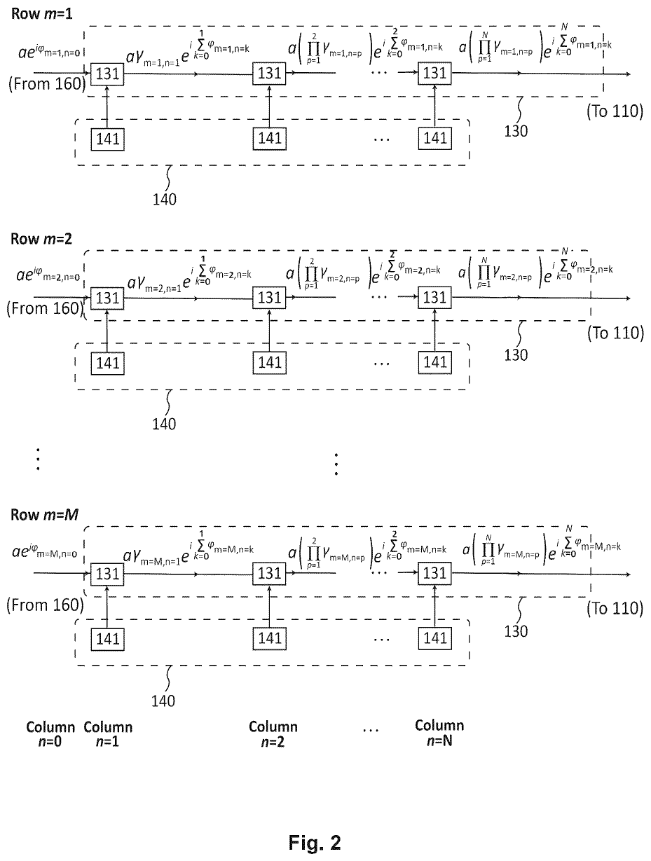

FIG. 2 shows a schematic diagram of columns (N) of optical phase shifters on row m, according to an embodiment of the invention. Each row comprises at least one optical phase shifter 141 configured to shift the optical phase of the optical field in the waveguide 130. The optical phase shifters are placed at the points 131 on the waveguides 130. Each optical phase shifter 131 is configured to cause the optical phase of the optical field in the waveguide to be shifted (by the optical phase shift φ_{m,n}) and a portion of optical field from the waveguide be lost (by the factor γ_{m,n}), with α denoting the amplitude of the optical field prior to traversing through the optical phase shifters. Each m of the M optical waveguides 130 is configured to receive an optical field of wavelength λₒ that may be represented using the plane wave approximation αe^{iφ}_{m,n}, with α and φ_{m,n} respectively denoting the amplitude and phase of the optical field sent to each of the waveguides. The subscripts m and n respectively, again denote the array row and column of phase shifters in 140.

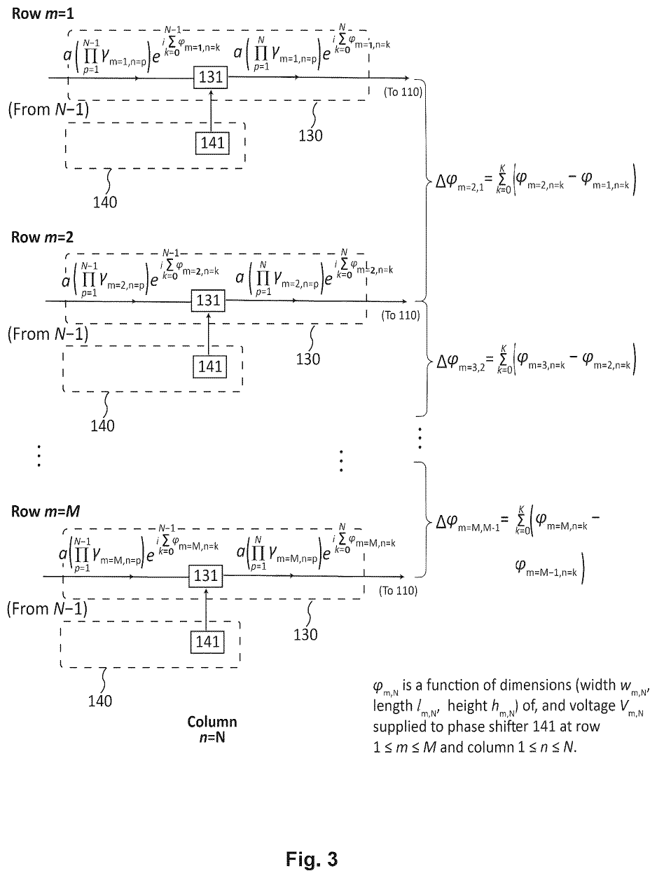

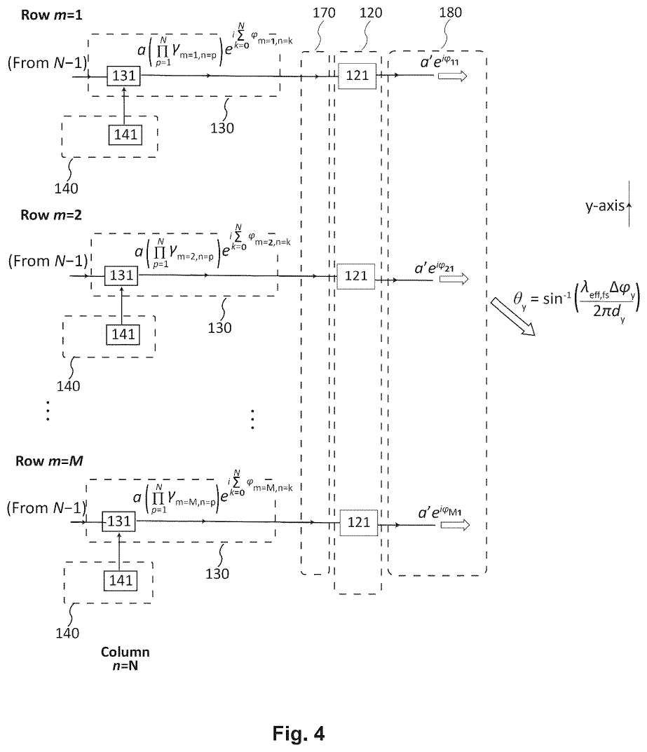

FIG. 3 shows a schematic diagram similar to FIG. 2, but shows the rows of the OPA on the last (n=N) column, according to an embodiment of the invention. Each column comprises an array 140 of optical phase shifters 141 configured to shift the optical phases of the optical field in the waveguides 130 to define an optical phase difference Δφₘ between the adjacent optical waveguides. Waveguides 130 are connected to waveguides 110 that is perturbed by a plurality 120 of scatterers 121 (see FIG. 4). Each scatterer 121 causes a portion of the optical field in the waveguide 130 to be evanescently coupled 170 (see FIG. 4) and be scattered out-of-plane 180, i.e., in the y-dimension. The subscripts m and n respectively denote the array row and column of phase shifters in 140.

FIG. 4 summarizes the beam steering function of the OPA, and shows a schematic diagram illustrating the use of optical phase shifters to modulate the directionality of scattered optical beam in the y-axis θ_{y} on row m by shifting via optical phase shifter 141 the optical phases of the optical field in the waveguide 130 operably coupled to waveguide 110 to be evanescently coupled 170 and be scattered out-of-plane 180 by the scatterers 121, according to one embodiment. The subscripts m and n respectively denote the array row and column of phase shifters in 140. Δ_{eff,fs}, Δφ_{y}, and d_{y} are respectively the effective wavelength of the optical field in free-space, the optical phase difference of the optical field at the scatterers (in the y-direction), and scatterer pitch (in the y-direction). α′ is the approximated amplitude of the optical field scattered out-of-plane from each scatterer.

Beam directionality (or beam steering angle) θ of the OPA—which is a function of emitter pitch d, the distance between centers of neighbouring scatterers which act as emitters—may be designed based on the following equation:

$$θ = {sin}^{- 1} ( \frac{{λ}_{eff , fs}}{2 d} \frac{Δ ϕ}{π} ) \qquad ( 1 )$$

where
λ_{eff,fs}=λₒ/η_{eff,fs}, is the effective wavelength of optical field in free-space,
λₒ is the wavelength of the optical field,
η_{eff,fs} is the effective refractive index of the medium in free space, and
Δφ is the optical phase difference of the optical field at the emitters/scatterers 121.

The optical phases of the optical field in the waveguides 130, which determine the beam directionality in the y-direction/dimension, may be varied by changing the refractive index of the waveguides in the arrays. The optical phase shifters may comprise either a phase shifter based on thermo-optic effect, plasma dispersion effect, electro-optic effect (such as Pockel's effect), microelectromechanically adjusted evanescent field perturbations (which changes the effective refractive index of OPA waveguides), or material structural change (such as liquid crystal, ferroelectric, and phase change materials). The thermo-optic phase shifter may comprise a metal heater, an alloy heater, a ceramic heater, or a highly doped semiconductor heater; the plasma-dispersion effect-based doped phase shifter may comprise a pn-doped or a pin-doped semiconductor; the electro-optic effect-based phase shifter may comprise a Pockel's effect-based modulator such as Li₃NbO₃ and BaTiO₃, or a Kerr's effect-based modulator; the photonic microelectromechanical system switching phase shifter may comprise a microelectromechanical system switch that introduces variations in evanescent field perturbations to change the effective refractive index of the optical phased array waveguides; and the material structural change-based phase shifter may comprise a liquid crystal, a ferroelectric, or a phase change material. The phase shifters, which modify the refractive index of the waveguides in the OPA—may be the same as each other, or different, as needed for the particular intended function. The change in the refractive index may advantageously be induced by, for example electrically heating the waveguide (via thermo-optic effect), electrically changing the spatial carrier concentration (via plasma dispersion effect to modify a refractive index and absorption of the phase shifter) in a doped semiconductor waveguide and electrically changing the birefringence of the waveguide (via electro-optic effect). Heat, spatial carrier concentration change, and optical birefringence change in waveguides may be introduced by applying voltage respectively to the thermo-optic phase shifter (which may be a metal, ceramic/alloy such as indium tin oxide, or heavily doped semiconductor heater near the waveguides, by use of a doped/ion implanted semiconductor region that extends along the waveguide (hereafter, a doped semiconductor phase shifter), or by applying voltage to electro-optic phase shifter (which is formed using material with high electro-optic coefficient, for example that which exhibit Pockel's effect). The metal heater may be constructed using materials with high thermo-optical coefficient, including but not limited to titanium nitride (TiN), nickel-chromium (NiCr), and the doped semiconductor heater may include semiconductor material heavily doped with positively charged (p++) or negatively charged (n++) dopant. The doping concentration of the heavily doped heater region may be Nₐ~10²⁰ cm⁻³ for n++ heater, and N_{d}~10²⁰ cm⁻³ for p++ heater. Alternatively, a phase shifter based on plasma dispersion effect may comprise either a pn-doped or a pin-doped semiconductor. The doping concentration of the plasma dispersion effect-based doped semiconductor region may be Nₐ~10¹⁷ to 10¹⁸ cm⁻³ for the n-doped region, and N_{d}~10¹⁷ to 10¹⁸ cm⁻³ for the p-doped region. The doping on waveguides to enable spatial carrier concentration change in waveguides may be formed using a pn-junction or a pin-junction. A pn-junction is a junction having a region with positively charged dopant implanted to the waveguide (p-doped region) adjacent to a region with negatively-charged dopant implanted to the waveguide (n-doped region), while a pin-junction is a junction having a p-doped region adjacent to an non-doped region (or ‘intrinsic’ region) adjacent to an n-doped region. Phase shifter based on electro-optic effect may be constructed using material with high electro-optic coefficient, for example Li₃NbO₃ and BaTiO₃. In some embodiments, each of the thermo-optical heaters includes a doped region having doping concentration in the order of at least 10¹⁹ cm⁻³.

The phase shifters 141 may not extend along an entire length of the waveguides 130. The desired optical phase shift may be modified by varying the portion of the segments to which the phase shifter extends, creating an optical phase shifted region of each segment.

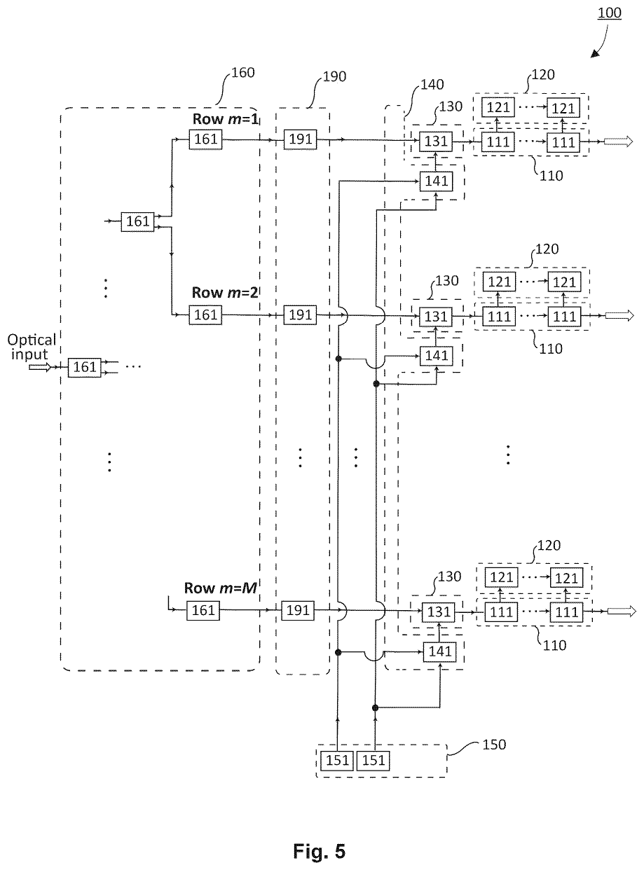

FIG. 5 shows a schematic diagram illustrating the use of one column of optical phase shifters to steer an optical beam by simultaneously modulating the optical phases of the optical field in the waveguides along the rows of the OPA using one set of electrical control elements connected to the phase shifters in an example of the model in FIG. 1, in accordance with an embodiment disclosed herein.

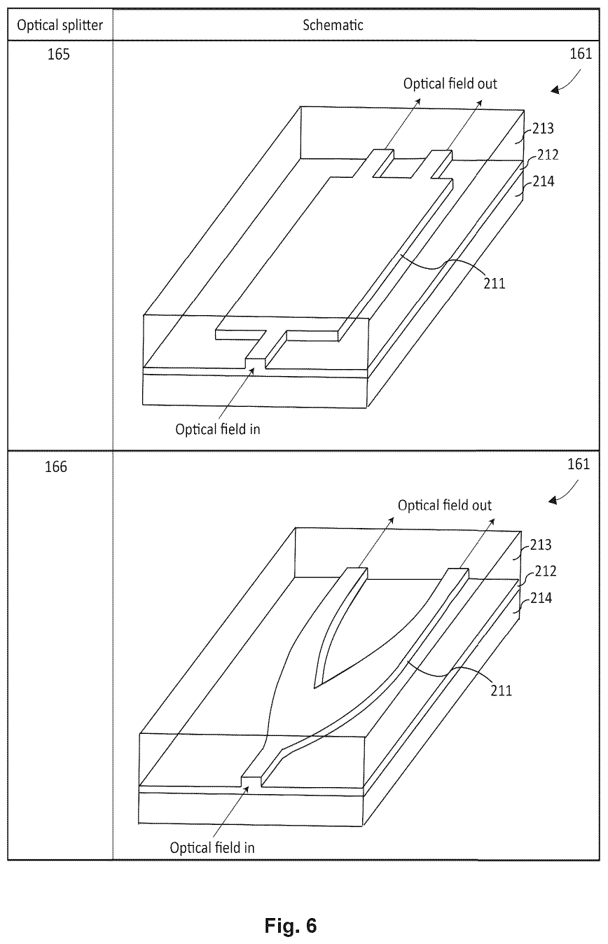

FIG. 6 is a table showing isometric schematic view of optical splitters 161 (multimode interferometer (MMI) optical splitter 165, and Y-splitter 166 in the two examples of the model of FIG. 6), in accordance with several embodiments disclosed herein. The optical splitters equally split the optical field to two splitter outputs of no or negligible optical amplitude difference with negligibly low or no optical phase difference. Although MMI splitter 165 has better fabrication tolerance and is typically of shorter length relative to Y-splitters 166, MMI splitter 165 is generally wavelength-sensitive. The optical splitters may be adapted for use in OPA 100 to form an optical splitter tree 160, which is formed by cascading the optical splitters 161 in multiple stages to provide M number of optical field of equal amplitudes and advantageously equal optical phase difference. For example, a three-, four-, and five-stage optical splitter tree would respectively produce M=2³, M=2⁴, and M=2⁵ number of optical field of equal amplitudes. The OPA 100 may comprise an optical splitter tree to produce the M number of optical field (instead of directly channeling M number of optical waveguides to the OPA 100) because the optical field is typically prone to optical phase fluctuations prior to optically coupling to an on-chip device (e.g., OPA 100) which is undesirable as the beam steering angle of OPA 100 is a direct function of optical phase difference of the optical field to the beam emitters 121. Advantageously by using an optical splitter tree, the optical phase relative to each of the respective optical field at the splitter tree outputs may be locked to ensure a reliable beam steering OPA device 100.

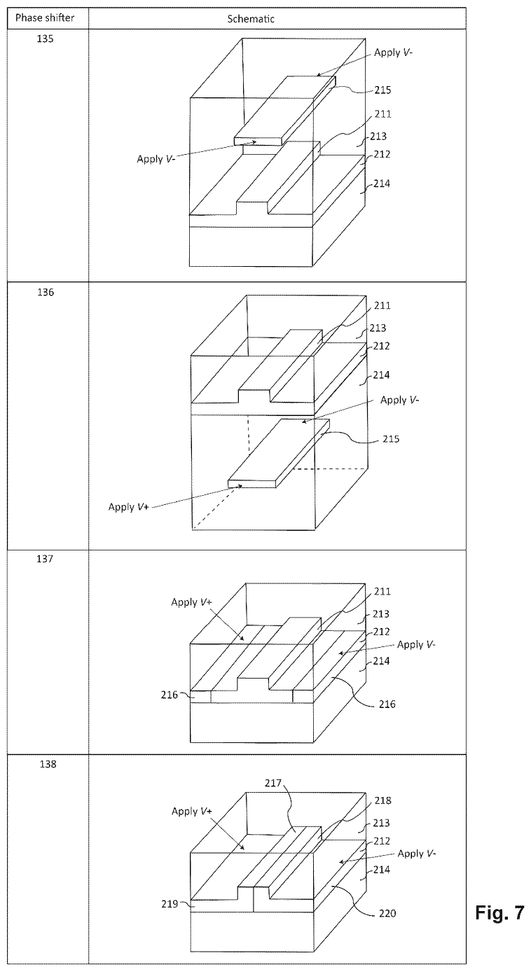

FIG. 7 is a table showing a partial isometric schematic view of different optical phase shifters (metal thermo-optic phase shifters 135 and 136 respectively above and below the optical waveguide 211 (which may be seamlessly extended to the outer slab region 212 in a rib waveguide), a highly doped semiconductor thermo-optic phase shifter 137, a pn-doped semiconductor phase shifter 138 in the four examples of the model of FIG. 7, that correspond to the optical phase shifters represented in FIG. 1) in accordance with several embodiments of optical phase shifters. For example, in accordance with one embodiment of OPA, the OPA 100 may comprise rows (M) of metal thermo-optic optical phase shifters (135 and/or 136) positioned adjacent to or otherwise integrated to total internal reflection-based waveguides 130 formed from Si₃N₄. The thermo-optic phase shifters 135 (an example of optical phase shifters 141) comprising titanium nitride (TiN) thermo-optical heaters 215 (above or within the overcladding 213) are configured to modulate the optical phases of the optical field in the waveguides 130, while the thermo-optic phase shifters 136 (also an example of optical phase shifters 141) comprising titanium nitride (TiN) thermo-optical heaters 215 (below or within the undercladding 214) are configured to modulate the optical phases of the optical field in the waveguides 130. The waveguide cladding may comprise undercladding 214 and overcladding 213. The heaters are configured to heat the waveguides, and thereby modulate the refractive index of the waveguides to shift the optical phase difference of the optical field between the waveguides in 130 to the waveguides 110 where the beam emitters 121 are positioned generally adjacent to the side walls of, or embedded in. The shift in optical phase difference in turn steers the optical beam along the y-direction. Each thermo-optical heaters 215 may be coupled to a metal structure (on an adjacent layer), electrically connected to another metal structure (on the top layer) through an electrical via. Advantageously, the heating of thermo-optical heaters may be introduced by applying voltage to electrical pads electrically connected to metal structure.

The thermo-optic phase shifters 137 may comprise n++ (heavily doped, for example with acceptor concentration Nₐ=1×10²⁰ cm³) doped (ion implanted) thermo-optical heaters 216 to modulate the optical phases of the optical field in the waveguides 130. The waveguide cladding may comprise undercladding 214 and overcladding 213. The heaters are configured to heat the waveguides, and thereby modulate the refractive index of the waveguides to shift the optical phase difference of the optical field between the waveguides in 130 to the waveguides 110 where the beam emitters 121 are positioned generally adjacent to the side walls of, or embedded in. The shift in optical phase difference in turn steers the optical beam along the y-direction. Each thermo-optical heater 216 may be electrically connected to a metal structure (on the bottom layer), electrically connected to another metal structure (on the top layer) through an electrical via. Advantageously, the heating of thermo-optical heaters may be introduced by applying voltage to electrical pads electrically connected to metal structure.

The optical phase shifter 138 may comprise pn-junction (p doped region labelled 217 and 219, and n-doped region labelled 218 and 220; for inner rib region and outer slab region of the waveguide which forms the phase shifter respectively), configured to modulate the optical phases of the optical field in the waveguides 130. Voltage applied across the pn-junctions which forms the optical phase shifter 141 introduces plasma dispersion effect in the waveguides 130 at 131, and thereby modulates the refractive index of the waveguides to shift the optical phase difference of the optical field between the waveguides in 130 to the waveguides 110 where the beam emitters 121 are positioned generally adjacent to the side walls of, or embedded in. The shift in optical phase difference in turn steers the optical beam along the y-direction. The doped semiconductor waveguide outer slab region 219 and 220 may be connected to a metal structure (on the bottom layer), electrically connected to another metal structure (on the top layer) through an electrical via. Advantageously, plasma dispersion effect may be introduced from the doped semiconductor waveguide outer slab region 219 and 220 by applying voltage to electrical pads electrically connected to metal structure.

The optical phase shift induced by optical phase shifters for beam steering differs depending on design parameters. For thermo-optic phase shifters, the optical phase shift depends on the temperature coefficient of the waveguide material dnldT, and the length of the heated waveguide region L. The induced optical phase shift may be conveniently described as a function of waveguide temperature increase ΔT and effective wavelength of the optical field in the waveguide λ_{eff,wg}.

$${Δφ}^{′} = \frac{2 π L Δ T}{{λ}_{eff , wg}} ( \frac{d n}{d T} ) \qquad ( 2 )$$

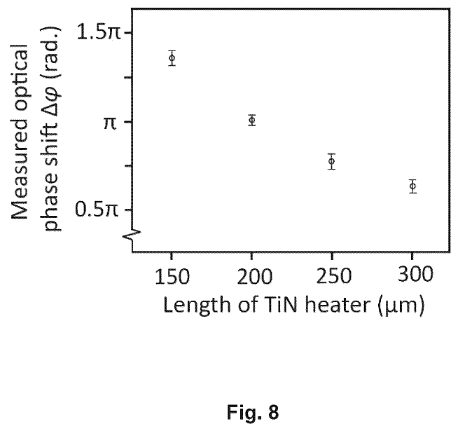

For example, to induce a 2π phase shift using ΔT=50 K (or 50 °C), with the parameters dn/dT=3.3×10⁻⁴ K⁻¹ and λ_{eff,wg}≈1 μm, the estimated length of the thermo-optic phase shifter is L≈60 μm. FIG. 8 shows an example experimental measurement plot of a phase shift Δφ with respect to length of modulation element (TiN metal heater with 2 μm width and 120 nm thickness) of a metal thermo-optic phase shifter (150 μm to 300 μm in the examples of the model of thermo-optic optical phase shifter 135 of FIG. 7) when modulated at a constant voltage, with a 2 μm SiO₂ overcladding gap between the metal heater and optical waveguide, according to one embodiment of metal thermo-optic phase shifter disclosed herein. For plasma dispersion effect based doped semiconductor optical phase shifters, the optical phase shift depends on the doping concentration on the waveguide which forms the phase shifter. For plasma dispersion effect based doped semiconductor optical phase shifters, the optical phase shift depends on the doping concentration on the waveguide which forms the phase shifter.

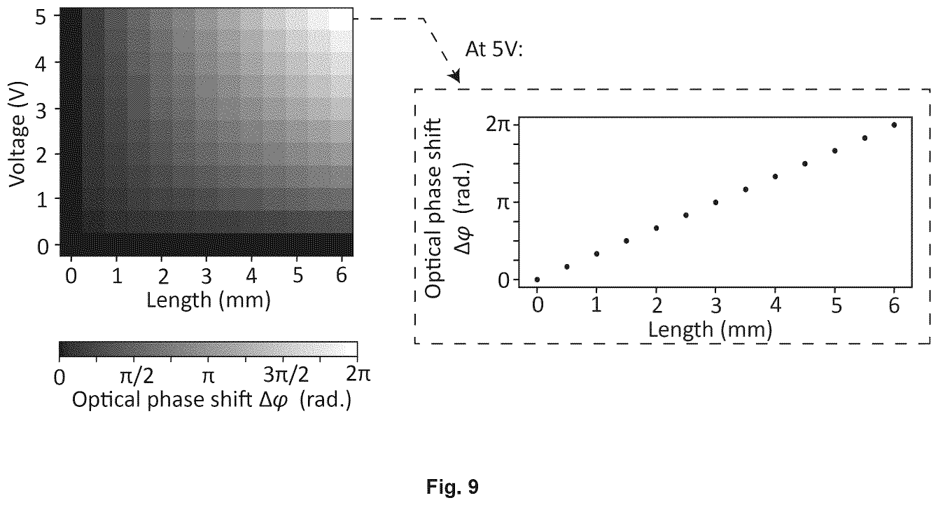

FIG. 9 shows an example numerical simulation plot of a phase shift Δφ with respect to voltage and length of modulation element (doped region) of a pn-doped optical phase shifter (0 to 6 mm in the examples of the model of pn-doped optical phase shifter 138 of FIG. 7) at 0 to 5 V, in accordance with an embodiment disclosed herein, obtained using Silvaco simulation software tool. In the simulation example, the acceptor Nₐ and donor N_{d} doping concentration are Nₐ=N_{d}=3×10¹⁸ cm⁻³ on 0.22 μm height optical waveguide partially etched with a 90 nm slab height. The simulation results indicate the linear optical phase shift relationship with physical length of the modulating element, with an optical phase modulation efficiency of 1.494 V·cm.

Advantageously, the optical phase modulating element (e.g., heater in thermo-optic phase shifters, and doped region in pn phase shifters) of such optical phase shifters 141 in the OPA 100 may be implemented with constant physical thickness and physical width (and thus constant physical area A). To maintain a constant optical phase shift Δφ′ across the OPA rows via independently-formed yet simultaneously-modulated phase modulating element across the OPA row m, the length L of the modulating element may be monotonically-varied according to an embodiment of the invention. For example, the monotonic variation may be a nonlinear variation according to an embodiment of the invention. Nonlinear variation may refer to reciprocal or other variation. For example, in a thermo-optic phase shifter, L may be reciprocally-varied or substantially reciprocally-varied across OPA rows m, according to an embodiment of the invention. Given that thermal energy is directly proportional to temperature change (i.e., Eₜₕₑᵣₘₐₗ=mass×specific heat capacity×ΔT), it may be derived from Equation (2) that: Δφ′∝Eₜₕₑᵣₘₐₗ. In thermo-optic phase shifters, electric energy E_{electric} is supplied to heat the phase shifters and induce optical phase shift Δφ′. Because E_{electric} is directly converted to Eₜₕₑᵣₘₐₗ in the heater which forms the thermo-optic phase shifter, the relationship Δφ∝E_{electric} provides the overall reciprocal relationship between induced optical phase shift Δφ′ and physical length L of the heater in a thermo-optic phase shifter:

$$\begin{matrix}{Δφ}^{′} ∝ {E}_{e l e c trical} \\ = {P}_{e l e c trical} Δ t \\ = \frac{{V}^{2}}{R} Δ t \\ = \frac{{V}^{2}}{\frac{ρ L}{A}} Δ t \\ ∝ \frac{1}{L}\end{matrix} \qquad ( 3 )$$

where Pₜₕₑᵣₘₐₗ is the thermal power, Δt is the period of time in which electrical energy is supplied, V is the electrical voltage, R is electrical resistance, and ρ is electrical resistivity of the material which forms the heater. In another example, in a pn-doped phase shifter, L may be linearly-varied or substantially linearly-varied across OPA rows m, according to an embodiment of the invention. The overall linear relationship between induced optical phase shift Δφ′ and physical length L of the doped region in the pn-phase shifter is:

$${Δφ}^{′} ∝ \frac{Δ {n}_{eff , wg} L}{{λ}_{o}} \qquad ( 4 )$$

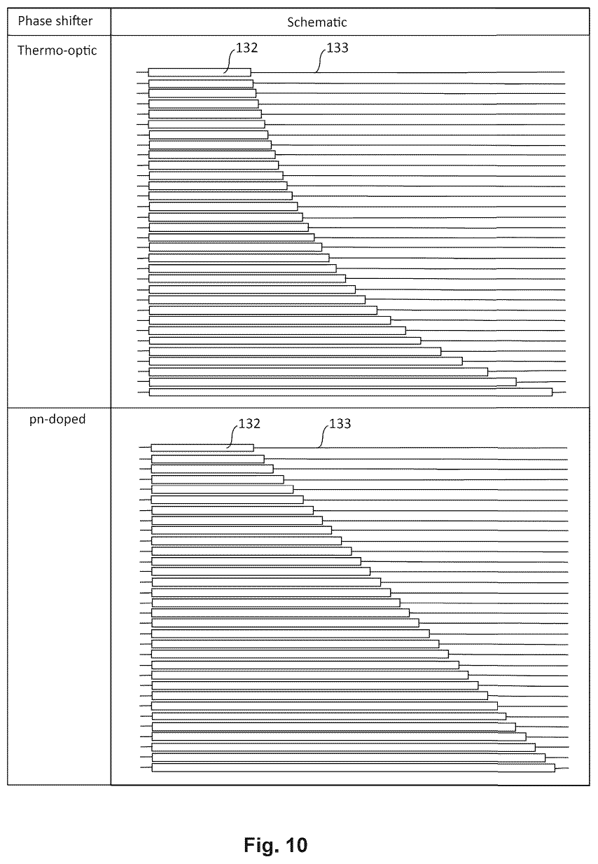

FIG. 10 is a table showing schematic top views of the length variations of the waveguide region 132 phase shift-modulated by phase shifter 131 across OPA row m for thermo-optic phase shifter 135, 136 and/or 137, and pn-doped optical phase shifter 138 in accordance with several embodiments of optical phase shifters. In contrast, waveguide region 133 is not phase shift-modulated by phase shifter 131. For thermo-optic phase shifter and pn-doped optical phase shifter, the modulating element length may vary nonlinearly (e.g., reciprocally 1/Lₘ=1/L₁+m/ΔL) and linearly (Lₘ=L₁+mΔL), respectively.

While the above examples provide for optical phase shifters having monotonically-varying lengths, it is to be appreciated that the optical phase shifter may be provided with monotonically-varying lengths, widths and/or heights in some other examples.

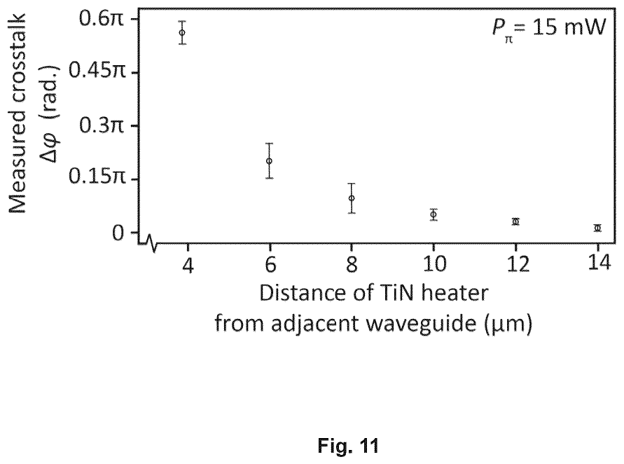

FIG. 11 shows experimental measurement results of resulting thermal crosstalk of optical phase shifters in accordance with several embodiments of the thermo-optic phase shifters disclosed herein at different physical gaps between adjacent phase shifters (4 μm, 6 μm, 8 μm, 10 μm, 12 μm and 14 μm, in the six examples of the distance of thermo-optic optical phase shifter 135. Advantageously, the phase shifters may be implemented with a sufficiently wide physical gap between adjacent independently-positioned phase shifters (e.g., 25 μm, for example) to prevent thermal crosstalk between the optical phase shifters, which enables the optical phase shift to be precisely defined to ensure a wide-angle optical beam steering from the simultaneously modulated OPA 100. Advantageously, other forms of optical phase shifters (pn-doped optical phase shifters, for example) may likewise be implemented using simultaneously modulated optical phase shifters 141 of monotonically-varying dimensions independently positioned on, below or otherwise integrated to the optical waveguides 130 to ensure precise definition of optical phase shift (and therefore optical phase difference) across the OPA rows m.

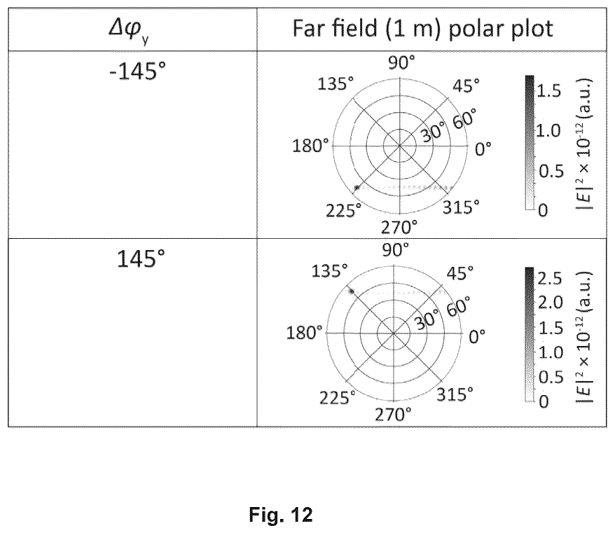

FIG. 12 is a table comparing polar plots of resulting far field intensities with respect to an azimuth and a zenith viewing angle at different optical phase differences of the input optical field sent to the waveguides Δφ_{y} (that is, optical phase Δφ in the y-direction) which may be modulated using phase shifters positioned on or otherwise integrated to the waveguides to the OPA, disclosed herein at different Δφ_{y} (−145° and 145° in the two examples in the model of FIG. 12). In accordance with one embodiment using 1.55 μm wavelength as the optical field, each row of waveguides are separated by 1.5 μm, with the scatterer formed from Si having a diameter of about 160 nm, the waveguide supports Transverse Magnetic optical waveguide mode with 0.7 μm width and 0.22 μm side wall thickness or height, partially etched with a 90 nm slab height along with air overcladding and SiO₂ undercladding. In one embodiment, one optical phase shifter 123 may be positioned on or otherwise integrated to each waveguide that is connected to the waveguides 110 for beam steering in the y-direction. Advantageously, when this configuration is obtained by simultaneously modulated (via control elements 150) optical phase shifters 141 of monotonically-varying lengths independently positioned on, below, or otherwise integrated to optical waveguide 130, the control complexity of the OPA may be significantly reduced.

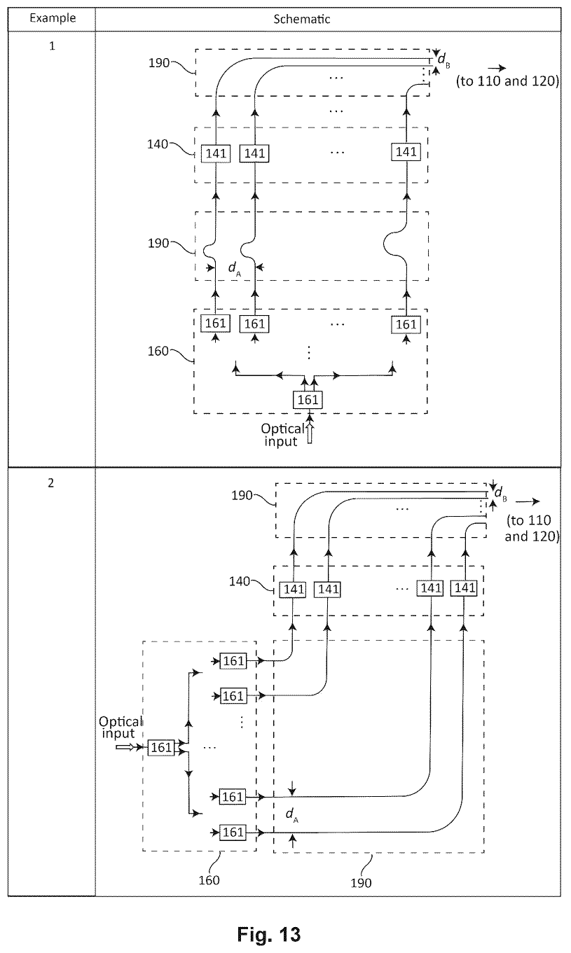

FIG. 13 is a table showing a schematic of different examples of optical phase compensating element 190, e.g., waveguides, in accordance with several embodiments of optical phase compensating elements. Advantageously, the compensating element 190 may be used to enable increasing the gap da between the optical phase shifters across rows m (e.g., to prevent thermal crosstalk in thermo-optic phase shifters) while also decreasing the gap d_{B} between optical waveguides 110 (and therefore scatterer/beam emitter distance d_{y}) across rows m to increase OPA field of view. To ensure that the optical phase difference at the point prior to optical waveguides 110 (and therefore beam emitters 120) is null prior to applying voltage supply to the optical phase shifters, the optical path length (physical length×effective refractive index of the optical waveguide) from the optical splitter tree 160 to the point prior to optical waveguides 110 across row m are ensured to be equal, by extending the physical length of the waveguide between the two points via optical phase compensating elements 190. In one embodiment, the optical path length from the optical splitter tree 160 to the point prior to waveguides 130 (which the array of optical phase shifters 141 are positioned on, below, or otherwise integrated to) are ensured to be equal to ease simultaneously modulating the optical phase shifters 141.

In accordance with another embodiment of the OPA, the OPA 100 may comprise rows (M) of any of several different types of optical phase shifters (metal thermo-optic optical phase shifters, pn-doped optical phase shifters, pin-doped optical phase shifters, doped semiconductor thermo-optic optical phase shifters, optical phase shifters based on thermo-optic effect). Optionally, the number of rows (M) of the OPA 100 and column (N) of phase shifters 140 may range between 2 to 10000, for example. The OPA 100 may be adapted for use in LiDAR systems, or free-space transceivers, for example.

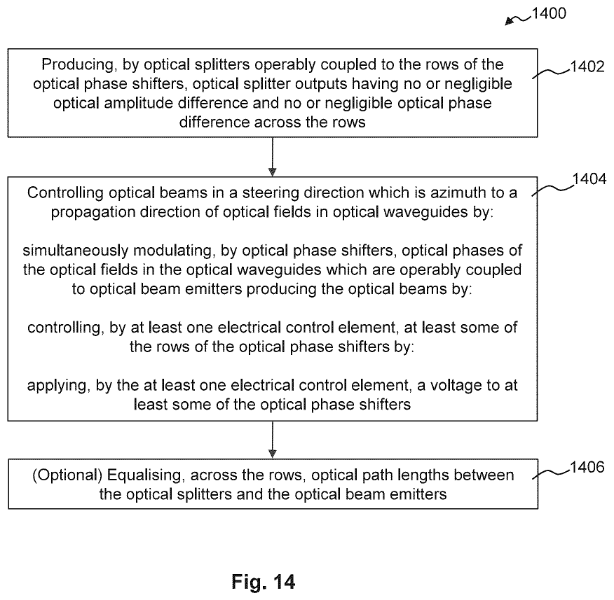

FIG. 14 shows a flowchart 1400 describing a method for operating an optical phased array which comprises photonic components for on-chip beam forming and steering.

In block 1402, the method includes: producing, by optical splitters operably coupled to the rows of the optical phase shifters, optical splitter outputs having no or negligible optical amplitude difference and no or negligible optical phase difference across the rows.

In block 1404, the method includes: controlling optical beams in a steering direction which is azimuth to a propagation direction of optical fields in optical waveguides by: simultaneously modulating, by optical phase shifters, optical phases of the optical fields in the optical waveguides which are operably coupled to optical beam emitters producing the optical beams, wherein the optical phase shifters having monotonically varying dimensions across rows thereof, and wherein each optical phase shifter traverses at most one of the optical waveguides. The simultaneous modulating may be by controlling, by at least one electrical control element, at least some of the rows of the optical phase shifters, wherein a count of the at least one electrical control element is less than a count of the rows of the optical beam emitters. The control by at least one electrical control element may be by applying, by the at least one electrical control element, a voltage to at least some of the optical phase shifters.

In block 1406, the method may optionally include equalising, across the rows, optical path lengths between the optical splitters and the optical beam emitters. This may be done by having first optical phase compensating elements operably coupled between the optical splitters and the rows of optical phase shifters; or having, in cooperation with the first optical phase compensating elements, second optical phase compensating elements operably coupled between the rows of the optical phase shifters and the optical beam emitters.

It is to be appreciated that the above-described sequence of the method 1400 may be modified or interchanged.

From the foregoing disclosure and detailed description of certain embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An optical phased array comprising:
photonic components for on-chip beam forming and steering, the photonic components comprising:
optical phase shifters having monotonically varying dimensions across rows thereof and operably configured to simultaneously modulate optical phases of optical fields in optical waveguides which are operably coupled to optical beam emitters, wherein each optical phase shifter traverses at most one of the optical waveguides;
optical splitters having optical splitter outputs operably coupled to the rows of the optical phase shifters, the optical splitters being operably configured to produce the optical splitter outputs, being the optical fields, having no or negligible optical amplitude difference and no or negligible optical phase difference across the rows;
first optical phase compensating elements operably coupled between the optical splitters and the rows of the optical phase shifters; and
second optical phase compensating elements operably coupled between the rows of the optical phase shifters and the optical beam emitters;
wherein the first optical phase compensating elements and the second optical phase compensating elements are operably configured, in cooperation, to equalise, across the rows, optical path lengths between the optical splitters and the optical beam emitters by extending physical lengths of the optical waveguides between the optical splitters and the optical beam emitters to ensure products of physical lengths and effective refractive indexes of the optical waveguides are equal.

2. The optical phased array of claim 1, further comprising:
at least one electrical control element operably configured to control at least some of the rows of the optical phase shifters, wherein a count of the at least one electrical control element is less than a count of the rows of the optical phase shifters.

3. (canceled)

4. (canceled)

5. (canceled)

6. The optical phased array of claim 2, wherein the count of the at least one electrical control element is one, and the at least some of the rows of the optical phase shifters includes all the rows of the optical phase shifters.

7. The optical phased array of claim 1, wherein the optical phase shifters include thermo-optic phase shifters having nonlinearly varying dimensions.

8. The optical phased array of claim 1, wherein the optical phase shifters include pn-doped or pin-doped phase shifters having linearly or substantially linearly varying dimensions.

9. The optical phased array of claim 1, wherein the optical phase shifters include at least two types of optical phase shifters selected from the group consisting of thermo-optic phase shifter, plasma-dispersion effect-based doped phase shifter, electro-optic effect-based phase shifter, photonic microelectromechanical system switching phase shifter, and material structural change-based phase shifter.

10. The optical phased array of claim 1, wherein the optical phase shifters traverse at most partially along lengths of the optical waveguides.

11. (canceled)

12. The optical phased array of claim 1, wherein the optical phase shifters include thermo-optical heaters arranged in thermal cooperation with the optical waveguides, wherein each of the thermo-optical heaters includes a doped region having doping concentration in the order of at least 10¹⁹ cm⁻³.

13. The optical phased array of claim 1, wherein the optical phase shifters include plasma dispersion effect based optical phase shifters which are integral with the optical waveguides.

14. A method for operating an optical phased array which comprises photonic components for on-chip beam forming and steering, the method comprising:
controlling optical beams in a steering direction which is azimuth to a propagation direction of optical fields in optical waveguides by:
simultaneously modulating, by optical phase shifters, optical phases of the optical fields in the optical waveguides which are operably coupled to optical beam emitters producing the optical beams, wherein the optical phase shifters having monotonically varying dimensions across rows thereof, and wherein each optical phase shifter traverses at most one of the optical waveguides;
producing, by optical splitters operably coupled to the rows of the optical phase shifters, optical splitter outputs, being the optical fields, having no or negligible optical amplitude difference and no or negligible optical phase difference across the rows;
equalising, across the rows, optical path lengths between the optical splitters and the optical beam emitters by:
extending, via first optical phase compensating elements and second optical phase compensating elements, physical lengths of the optical waveguides between the optical splitters and the optical beam emitters to ensure products of physical lengths and effective refractive indexes of the optical waveguides are equal, wherein the first optical phase compensating elements are operably coupled between the optical splitters and the rows of the optical phase shifters and the second optical phase compensating elements operably are coupled between the rows of the optical phase shifters and the optical beam emitters.

15. The method of claim 14, wherein simultaneously modulating, by the optical phase shifters, the optical phases of the optical field in the optical waveguides is by:
controlling, by at least one electrical control element, at least some of the rows of the optical phase shifters, wherein a count of the at least one electrical control element is less than a count of the rows of the optical phase shifters.

16. (canceled)

17. The method of claim 15, wherein controlling, by the at least one electrical control element, the at least some of the rows of the optical phase shifters is by:
applying, by the at least one electrical control element, a voltage to at least some of the optical phase shifters.

18. (canceled)

19. (canceled)

20. The optical phase array of claim 1, wherein the monotonically varying dimensions of the optical phase shifters include widths and/or heights of the optical phase shifters.

21. The method of claim 14, wherein the monotonically varying dimensions of the optical phase shifters include widths and/or heights of the optical phase shifters.
